(19) United States
(12) Patent Application Publication
(10) Pub. No.: US 2026/0258732 A1
(43) Pub. Date: Sep. 3, 2026

(54) IMPROVED VARIABLE-PITCH STATOR AND METHOD FOR USING SUCH A STATOR

(71) Applicant: SAFRAN, Paris (FR)

(72) Inventors: William Henri Joseph RIERA, Moissy-Cramayel (FR); Simon Pierre Michel MARTIN, Moissy-Cramayel (FR); Frédéric TONG-YETTE, Moissy-Cramayel (FR)

(73) Assignee: SAFRAN, Paris (FR)

(21) Appl. No.: 19/474,147

(22) PCT Filed: Apr. 9, 2024
(86) PCT No.: PCT/FR2024/050466

§ 371 Date: Oct. 9, 2025

(30) Foreign Application Priority Data
Apr. 11, 2023 (FR) FR2303567

(51) Int. Cl. F01D 9/04; F01D 17/16

(52) U.S. Cl. CPC F01D 9/041; F01D 17/162; F05D 2240/12; F05D 2250/294

(57) ABSTRACT

A turbomachine stator extending about a central axis and including an inner wall and an outer wall delimiting an annular flow passage, a plurality of variable-pitch vanes, each vane extending radially in the annular flow passage between a base movably fixed to the outer wall, and a free end, the inner wall including a main profile and at least one circular platform arranged opposite the free end of one of the vanes, the platform including a main surface and at least one longitudinal groove, the platform being movable in rotation relative to the main profile between a first position in which a main axis of the groove is substantially parallel to the central axis, and at least a second position in which the main axis is transverse to the central axis.

### TECHNICAL FIELD

The present disclosure relates to the field of the variable-pitch stators in the ducted aeronautical turbomachines, in particular the compressor inlet guide vane stators, but not only.

### PRIOR ART

As is known, a turbomachine stator comprises vanes extending radially between an inner wall (the hub) and an outer wall (the casing). The inner wall and the outer wall define therebetween an annular flow passage for the flow of the gases from upstream to downstream of the engine. These stator vanes can be variable-pitch stator vanes, allowing pivoting each of them about a radial axis to modify their angle of incidence. Such a stator with variable-pitch vanes can for example be an inlet guide vane (IGV) for the high-pressure or low-pressure compressors.

These variable-pitch vanes are for example disposed on rotating platforms with a pivot on the casing and allow orienting the flow at the inlet of the compressor so as it is aligned with the leading edge of the rotor wheel located downstream. The opposite end of the vanes is a free end that is not in contact with the wall of the hub. These variable-pitch stator vanes are therefore cantilevered.

The variable-pitch vanes are generally movable between an aligned position and a pitched position. In the aligned position, the angle of incidence, which can be defined as the angle between the vane chord and the engine axis, is zero or small, for example less than 20°. This position allows the vanes to be aligned with the upstream flow. In the pitched position, the angle of incidence is high, for example, greater than 40°. This position allows reorienting the flow that reaches the rotor wheel located downstream. However, the modification of the angle of incidence of the variable-pitch vanes has consequences on the flow topology, in particular involving secondary flows that generate a pressure distortion. These unwanted secondary flows must be managed.

In the aligned position in particular, the pressure differential between the intrados and the extrados is low and little flow crosses the space between the free end of the vane and the surface of the hub, which generates few vortices, and therefore few pressure losses. However, the free ends of the vanes, in the vicinity of the hub wall, can undergo a corner separation type flow, often caused by a passing flow, which is a flow close to the hub wall starting at the intrados leading edge of the vane and impacting further downstream towards the trailing edge of the adjacent vane, on the extrados side. A corner separation can generate a vortex on the extrados face close to the trailing edge of the vane, which can generate pressure losses.

In the pitched position, the pressure gradient between the intrados and the extrados is high. This can create a transverse flow at the spacing between the free end of the vane and the hub wall, which can generate tip-leakage flows, and in particular a vortex called tip-leakage vortex, and therefore pressure distortions that may impact the downstream rotor wheel and promote the triggering of the surge phenomenon.

To manage these secondary flows, it is known to use surface treatment technologies, consisting of local modifications in the hub or casing wall delimiting the air flow path. For example, it is possible to place fins on the hub wall between two adjacent variable-pitch vanes in order to limit the consequences related to the passing flow and to the corner separation when the vanes are in the aligned position. Document FR3106614 A1 describes one example of a fin for managing the corner separations. These fins however have a negative impact on the stator performance when the vanes are in the pitched position.

Moreover, grooves can be made in the hub wall to limit the consequences of the appearance of tip-leakage vortices and pressure distortions when the vanes are in the pitched position. However, although they are useful for large pitch angles, such grooves are less useful when the vanes are in the aligned position, and are even likely to degrade the stator performance by generating unwanted vortices.

In other words, although these technologies offer advantages for some types of flow, they imply a degradation of the stator performance for other types of flow, and are therefore difficult to integrate.

There is therefore a need for a system that can at least partly overcome the aforementioned drawbacks, and improve the performance of the pitched stator regardless of the aligned or pitched position of the vanes, without degrading its performance when they change position.

### DISCLOSURE OF THE INVENTION

The present disclosure relates to a turbomachine stator extending about a central axis and comprising:
an inner wall and an outer wall delimiting an annular flow passage,
a plurality of variable-pitch vanes, each vane extending radially in the annular flow passage between a base movably fixed to one of the inner wall or of the outer wall, and a free end,
the other of the inner wall or of the outer wall comprising a main profile and at least one circular platform arranged opposite the free end of one of the vanes, the platform comprising a main surface and at least one longitudinal groove, the platform being movable in rotation relative to the main profile between a first position in which a main axis of the groove is substantially parallel to the central axis, and at least a second position in which the main axis is transverse to the central axis.

In the present disclosure, the terms “axial direction”, “radial direction” and their derivatives are defined relative to the central axis of the stator, which is also the central axis of the turbomachine, about which the moving parts (the rotors) thereof rotate. Preferably, the stator is generally axisymmetric about the central axis. Similarly, the terms “upstream” and “downstream” are understood relative to the normal flow direction of the gases in a turbomachine, from the inlet to the outlet nozzle, passing successively through the compressors, the combustion chamber and the turbines.

It is understood that the stator vanes are fixed to either of the radially inner wall and of the radially outer wall, in a movable manner by being configured to pivot relative to this wall about a radial axis. The end of the vanes opposite to the end that is fixed to one of the inner or outer wall is a free end, which is not in contact with the other of the inner or outer wall. A space therefore exists between this wall and the free end.

The platform is a portion of the inner or outer wall, this portion being movable relative to the rest of the inner or outer wall. The platform, which is circular, is in particular able to pivot about a radial axis passing through the center of the platform. It is thus understood that the platform, particularly its main surface, is in line with the main profile of the inner or outer wall, the main profile comprising the portion of the surface of the inner or outer wall other than the platform, delimiting the annular air flow passage.

The main surface of the platform is, in other words, the reference surface of the platform, in the absence of grooves/recesses or projections/protrusions. It is thus understood that the longitudinal groove is a portion of the platform that is hollowed out relative to its main surface, forming a slot comprising a first dimension, its length, greater than a second dimension, its width. The main axis of the groove is an axis parallel to its length.

In the first position, the main axis of the groove is substantially parallel to the central axis, for example parallel to the central axis to within more or less 2°. It is thus understood that in the first position, the groove extends mainly in the axial direction of the turbomachine. In the second position, the main axis is transverse to the central axis, forming for example an angle greater than 45° relative to the latter.

It is thus possible to modify the orientation of the groove relative to the central axis and therefore relative to the flow of the incident gases, by pivoting the platform between the first and the second position. The longitudinal groove thus has a more or less significant influence on the flow depending on its orientation, which can thus be adapted according to the flight conditions and the pitch angle of the stator vanes. Particularly, when the vanes are in the pitched position, the groove in the second position allows limiting the consequences of the appearance of tip-leakage vortices and pressure distortions. Conversely, when the vanes are in the aligned position, the groove can be disposed in the first position in which it is aligned with the main flow and does not disturb it or only slightly. This device thus allows improving the performance of the stator in the pitched position, without degrading it in the aligned position. The overall performance of the turbomachine is therefore improved.

In some embodiments, in the second position, the main axis of the groove is perpendicular to the central axis. This allows maximizing the effect of mitigating the consequences related to the occurrence of tip-leakage vortices and pressure distortions by creating a channel dug between the intrados and the extrados of the stator vanes.

In some embodiments, the stator is configured such that, when a pitch angle between a chord of the vane at the free end and the central axis is comprised between 0 and 20°, the platform is disposed in the first position, and when the pitch angle is comprised between 40 and 80°, the platform is disposed in the second position.

In other words, an aligned position of the vanes corresponds to a situation in which the pitch angle is comprised between 0 and 20°, preferably less than 10°, and a pitched position of the vanes corresponds to a situation in which the pitch angle is comprised between 40 and 80°, preferably equal to 60°. The movable platform thus allows adapting the orientation of the groove and its influence on the flow, effectively depending on the pitch angle of the vanes.

In some embodiments, the inner wall comprises the platform and, in the first position, the main surface of the platform is flush with the main profile of the inner wall.

By “flush”, it is understood that the main surface of the platform is in line with the main profile of the inner wall, without positive or negative level difference that is to say without steps and without cavities. Given the annular shape of the stator, the radially inner wall of the stator, delimiting the annular flow passage, has a curved shape. It is understood that the main surface of the platform therefore has the same curved shape, and consequently the same radius of curvature, as the main profile of the inner wall. Thus, in the first position, the main surface of the platform is integrated and merged with the main profile of the inner wall.

This configuration allows limiting the impact of the movable platform on the incident flow when the vanes are in the aligned position, the groove being further aligned with the central axis and said flow.

In some embodiments, the platform comprises at least one longitudinal fin projecting from the main surface, extending between a first rim of the platform and a lateral side of the at least one groove, and having an elongated shape in the direction of the main axis of said groove.

Unlike the groove forming a recess relative to the main surface of the platform, the fin forms a protrusion relative to said main surface. It is understood that the fin extends mainly longitudinally, that is to say along an axis substantially parallel to the main axis of the groove, by being disposed on one side thereof.

Consequently, when the platform is in the first position, corresponding to a situation in which the vanes are in the aligned position, the fin is disposed between two adjacent vanes, and extends mainly axially along the central axis. This fin constitutes a “wall” blocking the transverse flows (the passing flows) which connect the intrados of a vane to the extrados of the adjacent vane, allowing limiting the negative consequences related to the corner separation when the vanes are in the aligned position.

When the platform is pivoted towards the second position, the fin also pivots and is no longer located between the two adjacent vanes, but upstream or downstream of a vane, depending on the direction of rotation of the platform. Given the convex shape of the inner wall and of the platform, the height at which the fin projects relative to the main profile of the inner wall is thus reduced when moving to the second position. It is thus possible to improve the performance of the stator when the vanes are in the aligned position thanks to the presence of the fin between the adjacent vanes, while limiting the impact of this fin when the vanes are in the pitched position.

In some embodiments, the fin comprises an inclined plane extending from a base of the main surface to a top, the base of the inclined plane being adjacent to the lateral side of the groove and the top being adjacent to the first rim of the platform, such that in the first position, the top projects relative to the main profile of the inner wall, and in the second position, the top is flush with said main profile.

It is understood that the base of the inclined plane is located at the main surface of the platform, in the vicinity of the groove, the inclined plane rising relative to the main surface away from the groove, to the top. In the first position, the fin projects both from the main surface of the platform and from the main profile of the inner wall, thus limiting the negative consequences related to the corner separation when the vanes are in the aligned position.

In the second position, the top of the inclined plane is flush with the main profile of the inner wall. Consequently, the fin projects from the main surface of the platform but is disposed below the level of the surface of the main profile of the inner wall. This allows limiting its impact on the flow when the vanes are in the pitched position.

Furthermore, the inclined plane constitutes a gentle slope, connecting the main profile of the inner wall to the main surface of the platform. Thus, when in the second position, the fin is located on the downstream part of the platform along the flow direction of the gases, the inclined plane constitutes an upward slope which connects to the main profile of the inner wall, which allows limiting the effects of upward step and therefore limiting the losses on the downstream part of the vane.

In some embodiments, in the second position, a second rim of the platform disposed at one end of the platform diametrically opposite to the first rim, is recessed relative to said main profile.

It is understood that the main surface comprises the second rim, which is flush with the main profile of the inner wall when the platform is in the first position, and which is recessed relative to said main profile when the platform is in the second position. In other words, the recess is generated by the difference in height between the main profile of the inner wall and the second rim, creating a step. The convex shape of the inner wall and of the platform thus allows, during rotation of the platform, creating this recess and thus providing an additional groove, in addition to the longitudinal groove machined in the platform.

This surprising effect is all the more advantageous when, in the second position of the platform, the second rim is disposed on an upstream side of the platform. Indeed, the additional groove thus created is disposed at the leading edge of the vanes in the pitched position, allowing limiting the dynamics of creation of tip-leakage vortices close to the leading edge of the vanes, and thus further improving the performance of the stator.

In some embodiments, in the second position, third and fourth rims of the platform, located on one side of the longitudinal ends of the groove, project relative to the main profile.

Given the convex shape of the inner wall and of the platform, the third and fourth rims of the platform located on the side of the longitudinal ends of the groove, that is to say the rims located at the upstream and downstream ends of the platform along the central axis, are flush with the platform in the first position and are raised relative to the main profile of said platform in the second position, after a rotation (for example of 90°) thereof.

The presence of these projections allows, in addition to the longitudinal groove oriented transversely relative to the central axis, contributing to reducing the dynamics of the tip-leakage vortices, and therefore the size of these vortices and their negative effect on the performance and operability of the stator.

In some embodiments, the stator comprises at least three longitudinal grooves parallel to each other.

It is thus understood that the main axes of the three grooves are parallel to each other. Similarly, the main axis of each of the grooves is substantially parallel to the central axis in the first position, and transverse, preferably perpendicular, to the central axis in the second position. The presence of at least three grooves allows limiting even more effectively the consequences of the appearance of tip-leakage vortices and pressure distortions, and thus further improving the performance of the stator in the pitched position, without degrading it in the aligned position.

In some embodiments, the stator is an inlet guide vane of a turbomachine compressor, the inner wall is a hub and the outer wall is an outer casing.

The present disclosure also relates to a turbomachine comprising a stator according to any one of the preceding embodiments.

The present disclosure also relates to a method for modifying the pitch of the vanes of a variable-pitch stator according to any one of the preceding embodiments, the method comprising the detection of the pitch angle of the vanes and, when the vanes are in an aligned position, the positioning of the platform in the first position, and when the vanes are in a pitched position, the positioning of the platform in the second position.

### BRIEF DESCRIPTION OF THE DRAWINGS

The invention and its advantages will be better understood upon reading the detailed description given below of different embodiments of the invention given as non-limiting examples. This description refers to the pages of figures appended, on which:

FIG. 1 represents a schematic longitudinal sectional view of a turbomachine,

FIG. 2 represents a partial view in a half cutting plane parallel to the central axis, of a variable-pitch stator according to one embodiment,

FIG. 3 represents a radial section of a variable-pitch stator vane, at its free end, in an aligned position (on the left) and in a pitched position (on the right),

FIG. 4 is a top view of a movable platform of the stator of FIG. 2,

FIG. 5 is a perspective view of the platform in the first position, in a bird's eye view from upstream,

FIG. 6 represents the platform of FIG. 5 in a front view from upstream,

FIG. 7 represents the platform of FIG. 5 in a side view,

FIG. 8 is a perspective view of the platform in the second position, in a bird's eye view from upstream,

FIG. 9 represents the platform of FIG. 8 in a front view from upstream,

FIG. 10 represents the platform of FIG. 8 in a side view.

### DESCRIPTION OF THE EMBODIMENTS

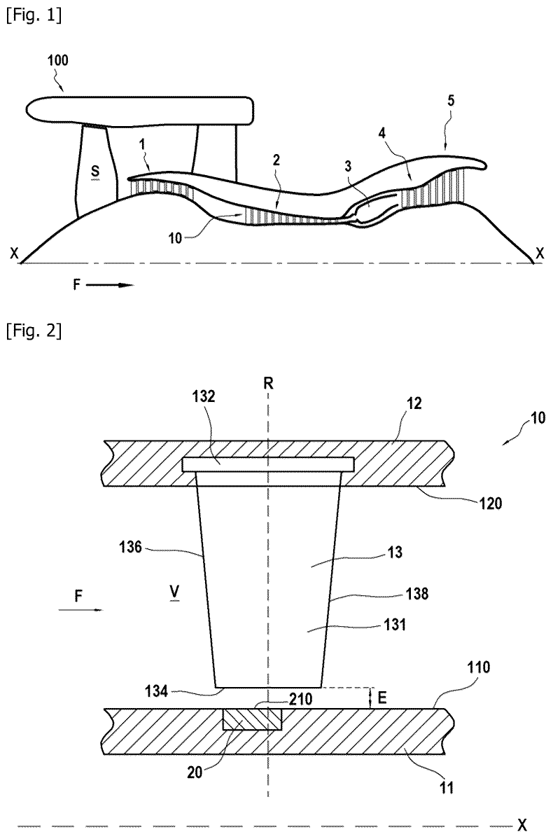

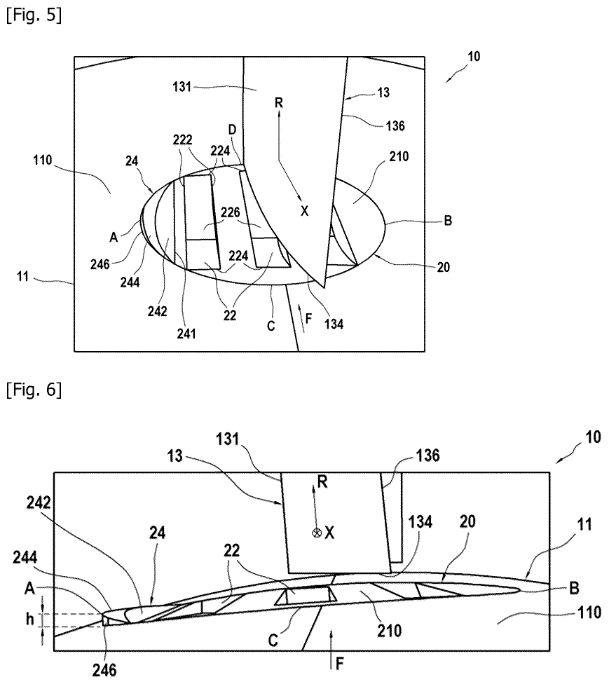

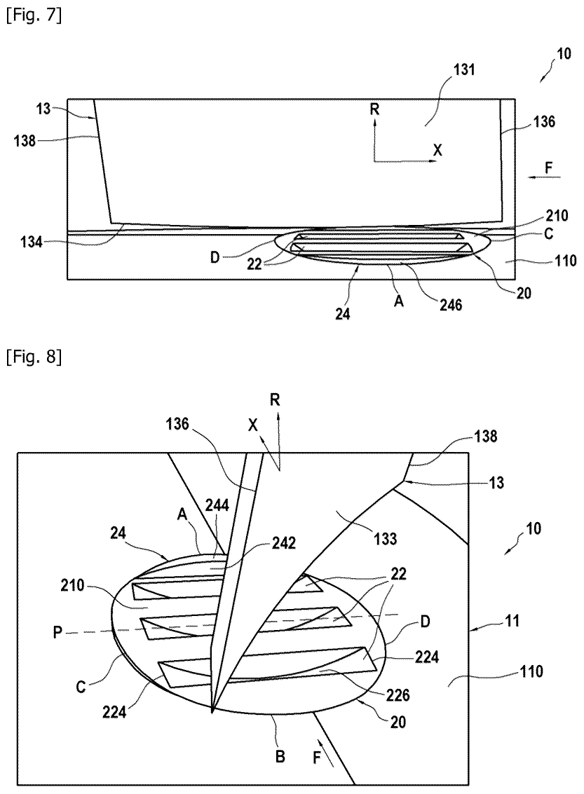

One embodiment of the present disclosure will be presented with reference to FIGS. 1 to 10.

The terms “upstream” and “downstream” are subsequently defined in relation to the flow direction of the gases through a turbomachine, indicated by the arrow F in FIG. 1 and the following figures. Moreover, the terms “inner” and “outer” are considered along a radial direction R perpendicular to the central axis X of the turbomachine. Thus, the outer wall 12 of the stator 10, for example, is farther from the central axis X than its inner wall 11 in the radial direction R.

FIG. 1 illustrates a turbofan engine 100 comprising, in a known manner from upstream to downstream, successively at least one fan S, at least one low-pressure compressor stage 1, one high-pressure compressor stage 2, one combustion chamber 3, at least one high-pressure turbine stage 4 and one low-pressure turbine stage 5. The rotors of the compressors 1, 2, of the turbines 4, 5 and of the fan S rotate about the central axis X of the turbomachine 100.

The stator 10 considered in the following example is an inlet guide vane of the high-pressure compressor 2, disposed upstream of the latter and allowing orienting the flow F entering this compressor, in particular to align it with the leading edge of the rotor wheel of the first stage of the high-pressure compressor 2. This example is however not limiting, the invention also applying to any stator comprising variable-pitch vanes.

The stator 10 comprises a hub 11 (the inner wall) and a casing 12 (the outer wall) delimiting therebetween an annular flow passage V in which the gas stream F flows. More specifically, the annular flow passage V is delimited by a main profile 110 of the hub 11 (the radially outer wall of the hub 11) and a main profile 120 of the casing 12 (the radially inner wall of the casing 12), the surfaces of the profiles 110, 120 being in contact with the gas stream F. The stator 10 further comprises a plurality of variable-pitch vanes 13 (only one is visible in the figures) extending in the flow passage V and being distributed circumferentially about the central axis X.

As illustrated in FIG. 2, representing a partial view of the stator 10 in a half cutting plane parallel to the central axis X, each vane 13 is fixed to the casing 12 and is not in contact with the hub 11 (unlike FIG. 1 representing the reverse configuration). It will be noted that this example is not limiting, the invention also applying to a situation in which the vanes 13 are fixed to the hub 11 and are not in contact with the casing 12.

More specifically, each vane 13 comprises a base 132 at a radially outer end, movably fixed to the casing 12. The base 132 is a rotating platform with a pivot to the casing 12, and is able to pivot about a radial direction R to adjust the pitch angle of the vane 13. Each vane 13 further comprises a leading edge 136, a trailing edge 138, an extrados 131 and a intrados 133. Moreover, the radially inner end of the vanes 13 is a free end 134. A space E exists between the free end 134 and the surface of the main plane 110 of the hub 11. The thickness of the space E is comprised between 0.1 and 5 mm. It will be noted that the space E is not necessarily constant and can vary between the leading edge 136 and the trailing edge 138, and also depending on the pitch angle of the vane 13.

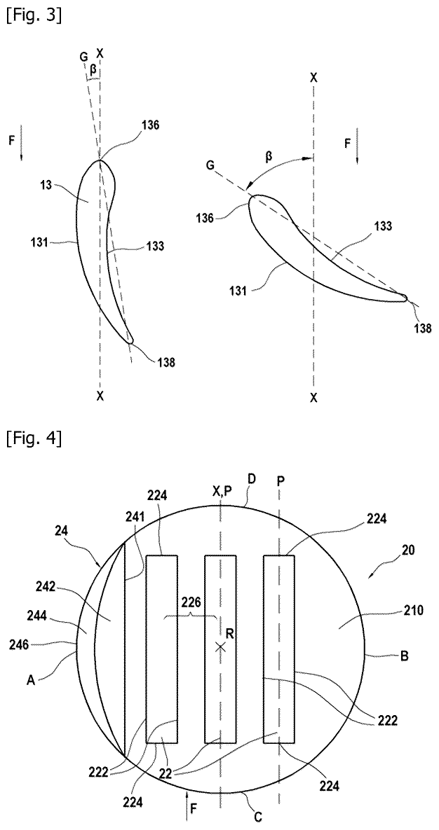

FIG. 3 represents a section of a vane 13, at the free end 134, in a left-aligned position, and in a right-aligned position. The pitch angle @ is the angle formed between the central axis X and the direction G of the chord of the vane 13 at this section, the chord being the straight line connecting the leading edge 136 and the trailing edge 138. The aligned position of the vane 13 corresponds to a situation in which the pitch angle B is comprised between 0 and 20°, preferably less than 10°, and the pitched position corresponds to a situation in which the pitch angle B is comprised between 40 and 80°, preferably equal to 60°.

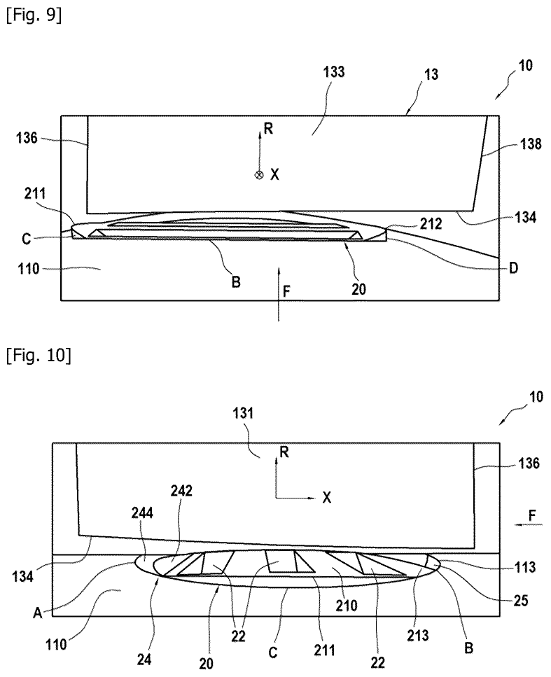

Moreover, the hub 11 comprises a plurality of platforms 20 (distinct from the platforms constituting the rotating bases 132 of the vanes 13), movable relative to the main profile 110 of the hub 11. It will be noted in this regard that the main profile 110 is a fixed portion of the hub 11 and of the stator 10 and represents most of the surface of the hub 11 (excluding platforms 20) in contact with the gas stream F. It has a curved shape, in other words convex relative to the central axis X. This curved shape of the main profile 110 is visible in particular in FIGS. 6 and 9.

The platforms 20 are movable in rotation between a first position and at least a second position. The first position of the platforms 20 is represented in FIGS. 4 to 7, and is adopted when the vanes 13 are in the aligned position. The second position of the platforms 20 is represented in FIGS. 8 to 10, and is adopted when the vanes 13 are in the pitched position.

A platform 20 in the first position will be described with reference to FIGS. 2 and 4 to 7, in which a single platform 20 is visible, it being understood that a platform 20 is disposed opposite each vane 13.

In FIG. 2 the platform 20 is represented in section in a simplified manner, without representing any irregularities in its main surface 210, such as grooves or fins described below. The platform 20 is integrated into the wall of the hub 11. In the configuration represented in FIG. 2, its main surface 210 is flush with the main profile 110 of the hub 11.

The main surface 210 of the platform 20 corresponds to the upper face of the platform 20 in contact with the gas stream, and to the portions called “regular” portions of the platform 20, which do not include any protrusion such as a fin or any recess such as a groove. The main surface 210 thus has a profile identical to the main profile 110 of the hub 11. In other words, the main surface 210 has a curvature identical to the curvature of the main profile 110 of the hub 11, such that in the first position, the main surface 210 is completely integrated into the main profile 110 and in line with the latter, as represented in FIG. 6 in particular.

It is understood that the number of platforms 20 that the hub 11 comprises is equal to the number of vanes 13 that the stator 10 comprises, a platform 20 being disposed facing the free end 134 of each vane 13. The diameter of a platform 20 has a value comprised between 30 and 100% of the length of the chord of the vane 13 at its free end 134. For example, for a chord comprised between 30 mm and 100 mm, the diameter of the platform 20 can be comprised between 30 mm and 70 mm.

A platform 20 is represented in FIG. 4 in a top view along its center of rotation, that is to say the radial direction R, the vane 13 being concealed. The platform 20 is circular with an axis of rotation coaxial with the radial direction R or parallel thereto. In other words, the platform 20 rotates about the same axis of rotation as the vane 13, or an axis parallel but in the vicinity of the latter.

To clarify the description, the circumference of the platform 20 is virtually and conventionally divided into four rims: a first rim A, a second rim B diametrically opposite to the first rim, a third rim C and a fourth rim D diametrically opposite to the third rim C.

In this example, the platform 20 comprises three longitudinal grooves 22. This example is however not limiting, the platform 20 being able to comprise a greater or lesser number of grooves 22. A groove 22 is a slot hollowed out in the platform 20, which therefore constitutes a recess relative to the main surface 210.

Each groove 22 extends mainly along a main axis P, which is a longitudinal direction of the groove, between the third rim C and the fourth rim D. Thus, each groove comprises two lateral sides 222 extending longitudinally parallel to the main axis P, and two longitudinal ends 224 extending perpendicular to the lateral sides and having a length smaller than the latter. The lateral sides 222 may for example extend over a length comprised between 70 and 90% of the diameter of the platform 20, for example over 50 mm. The width of the longitudinal ends 224 may be comprised between 1.5 and 5 mm. The three grooves 22 are disposed parallel to each other, their respective main axes P being parallel to each other. Preferably, a distance between two adjacent grooves 22 is greater than 1 mm.

It will be noted that the grooves 22 comprise a bottom 226 which is preferably curved, such that the bottom 226 connects the longitudinal ends 224 continuously. More specifically, the bottom 226 extends from a longitudinal end 224 of the groove, on the side of the third rim C for example, at the same level as the main surface 210 (that is to say at the same height), gradually sinks relative to the level of the main surface 210 to a maximum depth, then gradually goes back to the opposite longitudinal end 224 on the side of the fourth rim D. This configuration is clearly visible in FIG. 8, and allows disturbing the flow of the gas stream F as little as possible when the platform 20 is in the first position. Preferably, the depth of the grooves 22 is such that a depth/width ratio (where the width is the width of the longitudinal ends 224) is comprised between 1 and 2. In other words, the depth can be comprised between 1.5 mm and 10 mm, preferably between 2 mm and 6 mm.

The platform 20 further comprises a fin 24 projecting from the main surface 210. The fin 24 is disposed between the first rim A of the platform 20 and a lateral side 222 of one of the grooves 22. It has an elongated shape in the direction of the main axis P of said groove 22.

The fin 24 comprises an inclined plane 242 extending from a base 241 to a top 244. The base 241 is at the same level (that is to say at the same height) as the main surface 210 and extends parallel to the lateral side 222 while being adjacent thereto. The top 244 is raised relative to the main surface 210, the inclined plane 242 thus forming a slope connecting the main surface 210, at the base 241, to the top 244.

An edge 246 of the fin 24 is adjacent to the first rim A, and may even be coincident therewith, following the curvature of said first rim A of the platform 20. In other words, the edge 246 of the fin 24 has the shape of an arc of a circle with a radius equal to the radius of the platform 20. The edge 246 forms a steep low wall allowing compensating, in the first position of the platform 20, for the difference in height between the top 244 and the main plane 110 of the hub 11. Furthermore, in this example, the top 244 is a surface connecting the top of the inclined plane 242 and the upper end of the edge 246. Typically, a height h of the fin, corresponding to the maximum height between the top 244 and the main surface 210 (or the main plane 110 when the platform 20 is in the first position), in other words the maximum height of the low wall formed by the edge 246, is determined so as to be comprised between 0.5 and 3 times the thickness of the boundary layer upstream of the platform 20, preferably equal to said boundary layer.

In the first position, the platform 20 is oriented such that the longitudinal grooves 22 are aligned with the central axis X. In other words, the main axis P of the grooves 22 is parallel to the central axis X. The third rim C and the fourth rim D are also aligned with the central axis X and the incident gas stream F. In other words, the fourth rim D is aligned with the third rim C and downstream of it relative to the central axis X and to the direction of the gas stream F, and the diameter joining the rims C and D is parallel to the central axis X. In this first position, the second, third and fourth rims B, C and D are flush with the main profile 110 of the hub 11, and are therefore disposed in line with it.

Moreover, the fin 24 is arranged on the side of the vane 13, in particular on the extrados side 131 thereof. In other words, the fin 24 is disposed between the vane 13 visible in the figures, and the intrados of the adjacent vane (not visible). Thus, the edge 246 of the fin 24, at the first rim A, projecting relative to the main profile 110, forms a low wall between these two adjacent vanes 13, blocking the passing flows between these adjacent vanes, when these are in the aligned position.

The platform 20 in the second position will then be described with reference to FIGS. 8 to 10.

The second position is obtained by a rotation of the platform 20, typically of 90°, from the first position, such that the first rim A, and therefore the fin 24, are at a downstream end of the platform 20 in the direction of the flow of the gas stream F.

In the second position, the longitudinal grooves 22 are preferably disposed perpendicular to the central axis X. More specifically, the main axis P of the grooves 22 is perpendicular to the central axis X. Preferably, in this position, the main axis P of the grooves 22 form an angle relative to the direction G of the chord of the vanes comprised between 10°and 50°, typically 30°. Furthermore, the first rim A and the second rim B are aligned with the central axis X, and the third rim C and the fourth rim D are disposed on either side of the central axis X. In other words, the first rim A is aligned with the second rim B and downstream of it relative to the central axis X and to the direction of the gas stream F, and the diameter joining the edges C and D is perpendicular to the central axis X.

Given the bulging shape of the main profile 110 and of the platform 20, the third rim C and the fourth rim D which were flush with the main profile 110, in the first position of the platform 20, are now raised relative to the main profile 110, in the second position of the platform 20.

Indeed, given the convex shape of the main profile 110, taking as reference an axis parallel to the central axis X and passing through the center of the platform, a height of the main profile 110 of the hub 11 is maximum along this axis, and decreases as moving away from this axis, perpendicular thereto.

According to this reference, the region of the main profile 110 disposed in alignment with the rims A and B (FIG. 8) is higher than the regions of the main profile 110 adjacent to the rims C and D. The rims C and D being at the same height as the main profile 110, in the first position (FIG. 6), are therefore raised relative thereto, in the second position (FIG. 9).

As illustrated in FIG. 9, representing the platform 20 in the second position in a front view on the upstream side, the third rim C and the fourth rim D thus form a protrusion 211, 212 respectively, projecting relative to the main profile 110 of the hub 11.

In the same way, the second rim B, which was flush with the main surface 110 of the hub 11 in the first position, in a region of lower height of said main profile 110 of convex shape according to the reference frame defined above (FIG. 6 in a front view), is recessed relative to the main profile 110 after rotation of the platform 20 of 90° towards the second position (FIG. 10 in a lateral view). Thus, at the second rim B, a step 25 is created between an end 213 of the platform 20 and a contour 113 of the main profile 110 of the hub 11.

The rotation of the platform 20 from the first position to the second position thus allows creating, in addition to the grooves 22 machined in the platform 20, a fourth groove which was not present in the first position, at the second rim B disposed upstream of the platform 20. This fourth groove is formed by the step 25 which is descending along the flow direction of the gas stream F, and is preferably located at 10% (+/−5%) of the chord of the vane 13, from the leading edge 136.

On the other hand, the fin 24 which formed a protrusion relative to the main profile 110 of the hub 11, in the first position (FIG. 6), and was disposed between two adjacent vanes, now no longer projects relative to said main profile 110, in the second position (FIG. 10), and is disposed downstream of the platform 20 relative to the flow direction of the gas stream F. More specifically, the edge 246 is “retracted” into the hub 11, such that the top 244 is flush with the main profile 110. Furthermore, the inclined plane 242 constitutes a gentle upward slope from the main surface 210 of the platform 20 to the main profile 110 of the hub 11.

Thus, in a method for modifying the pitch of the vanes 13 of the variable-pitch stator 10, a computing unit (not represented) controls both the base 132 of the vanes and the platforms 20. The platforms 20 may in particular be pivoted by an electric or hydraulic actuator, for example. The method thus comprises the detection of the pitch angle of the vanes 13 by the computing unit. When it is detected that the vanes 13 are in the aligned position, the computing unit positions the platforms 20 in the first position. When it is detected that the vanes 13 are in the pitched position, the computing unit controls the platforms 20 to pivot them and position them in the second position.

Although the present invention has been described with reference to specific exemplary embodiments, it is obvious that modifications and changes may be made to these examples without departing from the general scope of the invention as defined by the claims. Particularly, individual characteristics of the various illustrated/mentioned embodiments may be combined in additional embodiments. Consequently, the description and the drawings should be considered in an illustrative rather than restrictive sense.

It is also obvious that all the characteristics described with reference to one method are transposable, alone or in combination, to one device, and conversely, all the characteristics described with reference to one device are transposable, alone or in combination, to one method.

1. A turbomachine stator extending about a central axis and comprising:
an inner wall and an outer wall delimiting an annular flow passage, a plurality of variable-pitch vanes, each vane extending radially in the annular flow passage between a base movably fixed to one of the inner wall or of the outer wall, and a free end,
the other of the inner wall or of the outer wall comprising a main profile and at least one circular platform arranged opposite the free end of one of the vanes, the platform comprising a main surface and at least one longitudinal groove, the platform being movable in rotation relative to the main profile between a first position in which a main axis of the groove is substantially parallel to the central axis, and at least a second position in which the main axis is transverse to the central axis.

2. The stator according to claim 1, wherein, in the second position, the main axis of the groove is perpendicular to the central axis.

3. The stator according to claim 1, configured such that, when a pitch angle between a chord of the vane at the free end and the central axis is comprised between 0 and 20°, the platform is disposed in the first position, and when the pitch angle is comprised between 40 and 80°, the platform disposed in the second position.

4. The stator according to claim 1, wherein the inner wall comprises the platform and wherein, in the first position, the main surface of the platform is flush with the main profile of the inner wall.

5. The stator according to claim 1, wherein the platform comprises at least one fin projecting from the main surface, extending between a first rim of the platform and a lateral side of the at least one groove, and having an elongated shape in the direction of the main axis of said groove.

6. The stator according to claim 4, wherein the fin comprises an inclined plane extending from a base on the main surface to a top, the base of the inclined plane being adjacent to the lateral side of the groove and the top being adjacent to the first rim of the platform, such that in the first position, the top projects relative to the main profile of the inner wall, and in the second position, the top is flush with said main profile.

7. The stator according to claim 5, wherein the inner wall comprises the platform, and wherein, in the first position, the main surface of the platform is flush with the main profile of the inner wall, and wherein, in the second position, a second rim of the platform disposed at one end of the platform diametrically opposite to the first rim, is recessed relative to said main profile.

8. The stator according to claim 4, wherein the platform comprises at least one fin projecting from the main surface, extending between a first rim of the platform and a lateral side of the at least one groove, and having an elongated shape in the direction of the main axis of said groove, and wherein, in the second position, third and fourth rims of the platform, located on one side of the longitudinal ends of the groove, project relative to the main profile.

9. The stator according to claim 1, comprising at least three longitudinal grooves parallel to each other.

10. The stator according to claim 1, the stator being an inlet guide vane of a turbomachine compressor, the inner wall being a hub and the outer wall being an outer casing.

11. A turbomachine comprising a stator according to claim 1.

12. A method for modifying the pitch of the vanes of a variable-pitch stator according to claim 1, the method comprising the detection of the pitch angle of the vanes and, when the vanes are in an aligned position, the positioning of the platform in the first position, and when the vanes are in a pitched position, the positioning of the platform in the second position.
